(19) United States
(12) Patent Application Publication
(10) Pub. No.: US 2025/0067118 A1
(43) Pub. Date: Feb. 27, 2025

(54) RADIO FREQUENCY AND ACOUSTICALLY SHIELDED DOOR AND FRAME ASSEMBLY

(71) Applicant: Shielding Resources Group, Inc., Tulsa, OK (US)

(72) Inventor: Michael John Lahita, Owasso, OK (US)

(73) Assignee: Shielding Resources Group, Inc., Tulsa, OK (US)

(21) Appl. No.: 18/237,930

(22) Filed: Aug. 25, 2023

(51) Int. Cl. E06B 5/10

(52) U.S. Cl. CPC E06B 5/10

(57) ABSTRACT

A radio frequency and acoustically shielded door and frame assembly having an opening with a door frame. A first door leaf and a second door leaf are each hingedly attached to the door frame. A shielding media sheathes each of the door leaves. A conductive contact channel is attached to a perimeter of each door leaf, the conductive contact channel electromechanically bonded to the shielding media. A conductive flange extends along a door head and along a door jamb of the door frame. A conductive contact is attached to a bottom of each door leaf wherein the conductive flange is in electrical contact with the conductive contact channel and the conductive contact when the first door leaf and the second door leaf are in closed position.

### BACKGROUND OF THE INVENTION

### 1. Field of the Invention

The present invention relates generally to radio frequency (RF) and acoustic enclosure assemblies, and more particularly, to RF and acoustic shielding doors and frame assemblies having improved RF and acoustic attenuation for a shielded enclosure.

### 2. Description of the Related Art

Radio frequency (RF) shielded enclosures and doors are designed to provide a controlled environment which retains or repels radiated electromagnetic energy. To attain such an environment, a six-sided shield of ferrous or non-ferrous metals is required. The shield should have no holes or openings which would allow electromagnetic energy to penetrate the environment. In addition, the doors and framing provide acoustic isolation.

Developments continue to be made in RF shielding and RF shielded rooms for research, medical, military and other government uses. Enclosures with RF shielding, in some cases, also require soundproofing or acoustic insulation in order to protect against the transmission of sound from either within or outside of the shielded enclosure. In production environments, electronics require RF-noise free areas for testing and other activities. In medical environments, magnetic resonance images provided by MRI operations are distorted by RF that emanate from nearby elevator motors, cell phones, television stations, radio stations and even passing vehicles. In secure RF shielded environments, the need may be to keep electronic and/or audio transmissions from exiting the environment or to prevent electronic and/or audio eavesdropping from outside of the shielded enclosure.

RF and acoustic shielding occurs around the perimeter of the doors, namely at the seal, and also through the door panels. For acoustic purposes, control of the passage of sound waves focuses on the door seals as well as on the mechanical door for controlling and preventing the passage of sound waves through the air and also by vibration through materials. In addition to providing RF shielding and soundproofing, the doors must also be functional, and the RF and soundproofing seals must be designed in such a manner that they do not wear, break through use. Moreover, since door alignment is a common problem, any unsealed jams allow sound waves to travel through.

One example of a radio frequency and acoustic shielding door is Applicant's U.S. Pat. No. 9,828,798, which is incorporated herein in its entirety by reference.

In addition to RF and acoustic shielding, ballastic shielding of the door and frame assembly would be desirable.

Therefore, it is desirable to provide improved enclosure assemblies with RF and acoustic shielding doors and frames.

It is further desirable to provide a shielded enclosure having multiple doors which may be arranged in various configurations.

It is further desirable to provide RF and acoustic shielding doors for attenuating RF radiation and soundproofing in a myriad of environments, including medical and nonmedical.

It is yet further desirable to provide RF and acoustic shielding doors having an acoustic seal assembly that is adjustable so that a complete seal can be formed around the door head, door jamb and sill.

It is still yet further desirable to provide RF and acoustic shielding doors that provide RF attenuation and soundproofing for different frequencies within existing trim sizes.

It is still yet further desirable to provide an RF and acoustically shielded doors and frame assembly.

Other advantages and features of the invention will be apparent from the following description and from the claims.

### BRIEF SUMMARY OF THE INVENTION

The present invention is directed to a radio frequency and acoustically shielded door and frame assembly having a door frame and a pair of doors. The pair of doors includes a first door leaf and a second door leaf, each door leaf hingedly attached to the door frame. A shielding media sheathes each door leaf.

An optional removable mullion is located between the first door leaf and the second door leaf.

A conductive contact channel is attached to a perimeter of each door leaf. The conductive contact channel is electro-mechanically bonded to the shielding media.

A conductive flange extends along a door head and along a door jamb of the door frame.

In one configuration, the conductive flange circumnavigates the entire door header and door jamb of the door frame. The conductive flange includes an interior side strut, a frame strut attached to the interior side strut, and an exterior side strut attached to the frame strut.

A conductive contact is attached to a bottom of each door leaf.

The conductive flange is in electrical contact with the conductive contact channel and with the conductive contact when the first door leaf and the second door leaf are in a closed position.

### BRIEF DESCRIPTION OF THE DRAWINGS

FIG. 1 is an exterior plan view of a radio frequency (RF) and acoustically shielded door and frame assembly constructed in accordance with an illustrative embodiment of the invention disclosed herein;

FIG. 2 is an interior plan view of the assembly shown in FIG. 1;

FIG. 3 is a simplified diagrammatic view of the assembly shown in FIGS. 1 and 2 illustrating the various door swing alternatives;

FIG. 4 is a cross-sectional view taken along section lines 4-4 of FIGS. 1 and 2;

FIG. 5 is a vertical sectional view of the assembly;

FIG. 6 is top view of a doorsill of the assembly apart from the assembly; and

FIGS. 7A, 7B and 7C illustrate sectional views of a conductive flange extending along a door head and along a door jamb of the door frame of the assembly.

### DETAILED DESCRIPTION OF THE INVENTION

The devices and methods discussed herein are merely illustrative of specific manners in which to make and use this invention and are not to be interpreted as limiting in scope.

While the invention has been described with a certain degree of particularity, it is to be noted that many modifications may be made in the details of the construction and the arrangement of the elements and components of the devices and/or in the sequences and steps of the methods without departing from the scope of this disclosure. It is understood that the devices and methods are not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the process to be operated in a particular orientation. Terms, such as “connected,” “connecting,” “attached,” “attaching,” “join” and “joining” are used interchangeably and refer to one structure or surface being secured to another structure or surface or integrally fabricated in one piece.

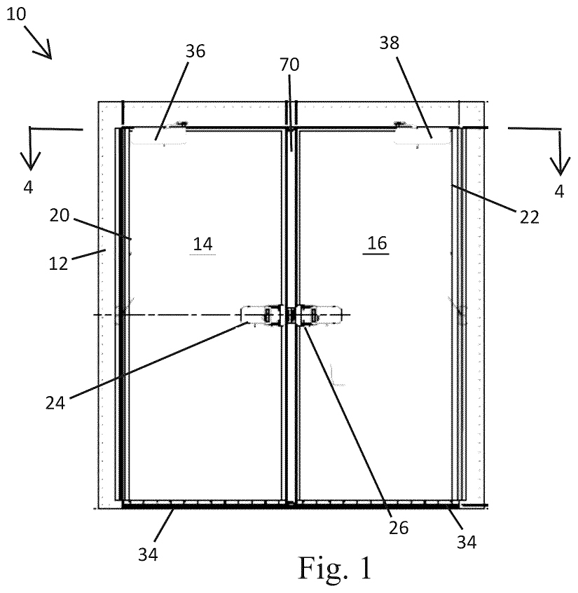

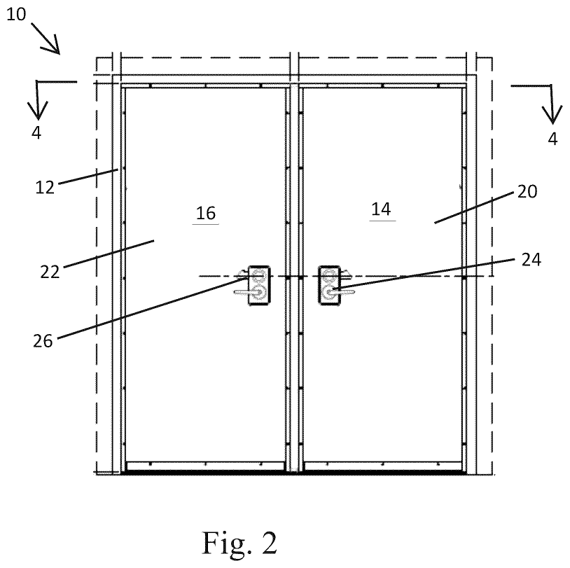

Referring to the drawings in detail, wherein like numerals of reference designate like elements throughout the several views. FIGS. 1 and 2 illustrate elevation views of a portion of an assembly 10 comprising a shielded enclosure 12 having an opening with a door frame. A first door leaf 14 and a second door leaf 16 each include a radio frequency (RF) and acoustic shielding door having improved RF and acoustic attenuation. The first door leaf 14 and the second door leaf 16 are designed for commercial and security applications, and provide opening and closing forces associated with conventional entry doors. In addition, the door leafs 14 and 16 may include single or double cylinder deadbolts, door closers 36 and 38, magnetic switches, medium or high security combination locks or other specified door hardware to suit the particular application.

As illustrated in Table 1 below, the enclosure assembly 10 exceeds the shielding effectiveness requirements of NSA 73-2A, IEEE 299, NACSIM 5204.

TABLE 1
S/E values based on minimum performance.

| Magnetic Field | | | Electric Field | | | Plane wave | | Microwave | |
|---|---|---|---|---|---|---|---|---|---|
| 10 | KHz | 30 dB | 10 | KHz | 100 dB | 50 MHz | 100 dB | 2 GHz | 70 dB |
| 100 | KHz | 50 dB | 100 | KHz | 100 dB | 100 MHz | 80 dB | 4 GHz | 65 dB |
| 1 | MHz | 60 dB | 1 | MHz | 100 dB | 400 MHz | 80 dB | 8 GHz | 60 dB |
| 10 | MHz | 75 dB | 10 | MHz | 100 dB | 1000 MHz | 75 dB | 10 GHz | 60 dB |
| 30 | MHz | 90 dB | 30 | MHz | 100 dB | | | 12 GHz | 55 dB |
| | | | | | | | | 18 GHz | 40 dB |

Each door leaf 14 and 16 is hingedly attached to a door frame 18. Each door leaf 14 and 16 is mounted to the door frame 18 using a commercial grade, full surface, security, piano-type hinge 20 and 22, respectively. Other types of hinges are possible within the spirit and scope of the invention.

Each door leaf 14 and 16 may optionally include a passage lockset 24 and 26 that complies with applicable Americans with Disabilities Act (ADA), the Uniform Federal Accessibility Standards and ANSI 156.2, Series 4000, Grade 1 requirements.

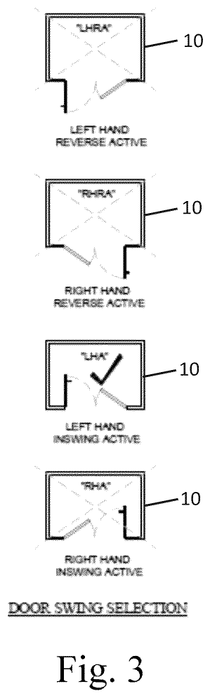

FIG. 3 illustrates simplified diagrammatic views of alternate arrangements for door swing selection. In FIGS. 1 and 2, first door leaf 14 is an active door leaf while second door leaf 16 is an inactive door leaf.

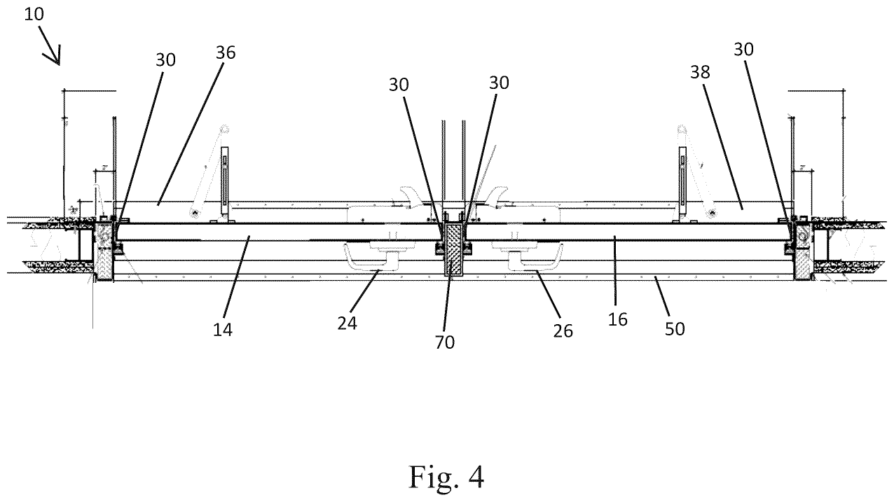

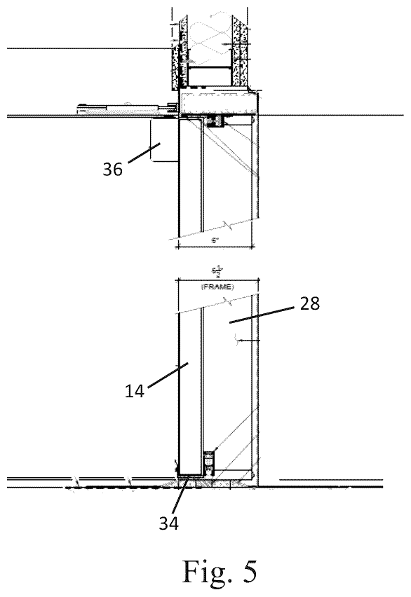

FIG. 4 illustrates a sectional view taken along section line 4-4 of FIGS. 1 and 2, while FIG. 5 illustrates a vertical sectional view.

Each door leaf 14 and 16 has an acoustically and RF insulated core that is sheathed with a shielding media, which in turn may optionally be sheathed with a decorative finish such as a wood veneer or a high pressure plastic laminate (not shown). In addition, each door leaf may include ballastic shielding media. The perimeter of each door leaf 14 and 16 is banded with a conductive contact channel 30 that is electro-mechanically bonded to the shielding media.

In addition, an angled contact 34 is mechanically attached at a bottom of each door leaf. The conductive contact channel 30 and the conductive angled contact 34 can be any suitable conductive material, such as silver, copper, gold, aluminum, zinc, lithium, nickel, steel, stainless steel or an alloy thereof, such as brass.

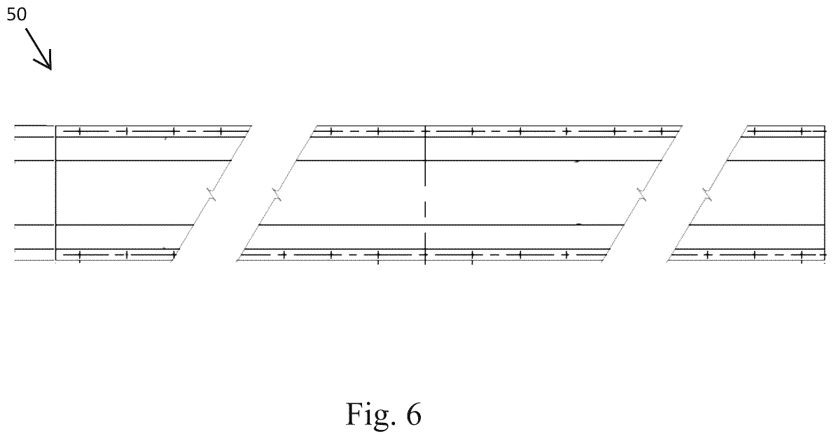

FIG. 6 illustrates a door sill 50 apart from the assembly. The door sill 50 includes a steel or stainless steel threshold that is electro-mechanically connected to the door frame. In addition, the door sill 50 may be single or double tapered to suit the particular application. Moreover, the door sill 50 may be configured in an ADA flush sill or a raised sill configuration.

The core of each door leaf 14 and 16 may be acoustically insulated, and each includes at least one acoustic or RF gasket seal assembly.

A conductive flange 60 extends along a door header and a door jamb 28 of the door frame. In one configuration, the conductive flange 60 circumnavigates the entire door header and door jamb of the door frame.

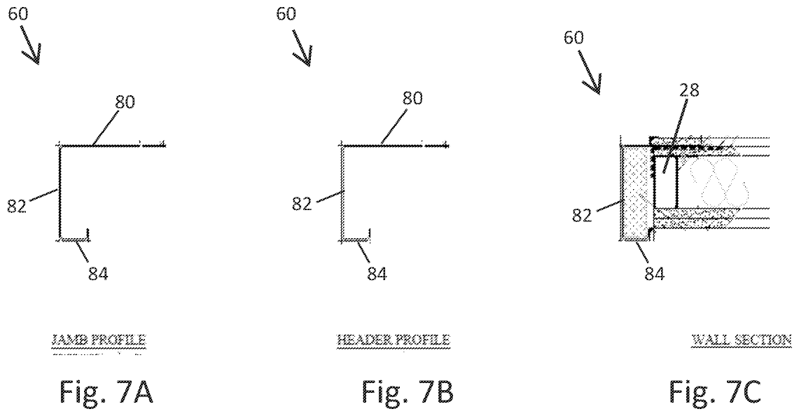

FIG. 7 shows sectional views of the conductive flange 60. FIG. 7A illustrates the conductive flange 60 apart from the door jamb 28. The conductive flange 60 includes an interior side strut 80, a frame strut 82 attached to the interior side strut, and an exterior side strut 84 attached to the frame strut. FIG. 7B illustrates the conductive flange 60 apart from the door header. FIG. 7C illustrates the conductive flange 60 at the door jamb 28 of the door frame. The interior side strut 80 is substantially parallel to the exterior side strut 84, and the frame strut 82 is spaced from the door jamb forming an enclosed void configured to retain acoustic isolation.

The first door leaf 14 and second door leaf 16 have the acoustic attention characteristics illustrated below in Table 2:

TABLE 2
Noise Isolation Class Test.

| | Source | Receiver | | Ambient | |
|---|---|---|---|---|---|
| Frequency | Level, | Level, | NR | Level, | Ambient |
| Band (Hz) | L_{P} (dB) | L_{P} (dB) | (dB) | L_{P} (dB) | Flags |
| 125 | 100 | 67 | 33 | 36 | |
| 160 | 103 | 68 | 35 | 34 | |
| 200 | 103 | 62 | 41 | 34 | |
| 250 | 99 | 55 | 44 | 36 | |
| 315 | 93 | 47 | 47 | 29 | NIC |
| 400 | 86 | 38 | 47 | 26 | 50 |
| 500 | 85 | 36 | 49 | 28 | |
| 630 | 90 | 41 | 49 | 23 | |
| 800 | 87 | 37 | 50 | 21 | |
| 1000 | 85 | 37 | 48 | 23 | |
| 1250 | 82 | 34 | 47 | 22 | |
| 1600 | 83 | 33 | 49 | 21 | |
| 2000 | 83 | 31 | 52 | 19 | |
| 2500 | 85 | 32 | 53 | 19 | |
| 3150 | 85 | 33 | 53 | 22 | |
| 4000 | 85 | 32 | 53 | 21 | |

| | |
|---|---|
| Source Level at one meter from tested surface | 109 |
| (dB, flat, 125-4k) | |
| Receiver Level at one meter from tested surface | 77 |
| (dB, flat, 125-4k) | |

A removable mullion 70 extends between the first door leaf 14 and the second door leaf 16. The mullion 70 is in electrical contact with a perimeter of the first door leaf 14 and the second door leaf 16. The mullion 70 may be configured as a hollow tube filled with insulation and/or acoustic and RF insulation.

Whereas, the invention has been described in relation to the drawings and claims, it should be understood that other and further modifications, apart from those shown or suggested herein, may be made within the scope of this invention.

What is claimed is:

1. A radio frequency and acoustically shielded door and frame assembly, which assembly comprises:
an opening with a door frame;
a first door leaf and a second door leaf, each said door leaf hingedly attached to the door frame;
a shielding media sheathing each said door leaf;
a conductive contact channel attached to a perimeter of each said door leaf, said conductive contact channel electro-mechanically bonded to said shielding media;
a conductive flange extending along a door head and along a door jamb of said door frame; and
a conductive contact attached to a bottom of each said door leaf, wherein said conductive flange is in electrical contact with said conductive contact channel and with said conductive contact when said first door leaf and second door leaf are in a closed position.

2. The assembly of claim 1 wherein each said door leaf includes radio frequency and acoustic shielding.

3. The assembly of claim 2 wherein each said door leaf includes ballastic shielding.

4. The assembly of claim 1 wherein said conductive contact channel is chosen from a group consisting of silver, copper, gold, aluminum, zinc, lithium, nickel, stainless steel, steel, and an alloy thereof.

5. The assembly of claim 1 wherein said conductive flange is chosen from a group consisting of silver, copper, gold, aluminum, zinc, lithium, nickel, stainless steel, steel, and an alloy thereof.

6. The assembly of claim 1 wherein said conductive contact is chosen from a group consisting of silver, copper, gold, aluminum, zinc, lithium, nickel, stainless steel and an alloy thereof.

7. The assembly as set forth in claim 1 including a removable mullion between said first door leaf and said second door leaf.

8. The assembly as set forth in claim 7 wherein said removable mullion is configured as a hollow tube filled with insulation.

9. The assembly as set forth in claim 1 wherein said conductive flange includes an interior side strut, a frame strut attached to said interior side strut, and an exterior side strut connected to said frame strut.

10. The assembly as set forth in claim 9 wherein said interior side strut is substantially parallel to said exterior side strut and said frame strut is spaced from said door jamb and said door header.

11. The assembly as set forth in claim 10 wherein said interior side strut, said frame strut, and said exterior side strut together form an enclosed void configured to retain acoustic insulation, RF insulation, and/or ballastic shielding.
